(19) United States
(12) Patent Application Publication
(10) Pub. No.: US 2016/0207385 A1
(43) Pub. Date: Jul. 21, 2016

(54) Daily Use Protective Vehicle Cover

(71) Applicants: Bobbie Ward, Oakland, CA (US); Ashleigh Ward, Oakland, CA (US)

(72) Inventors: Bobbie Ward, Oakland, CA (US); Ashleigh Ward, Oakland, CA (US)

(21) Appl. No.: 14/996,791

(22) Filed: Jan. 15, 2016

Related U.S. Application Data
(60) Provisional application No. 62/104,571, filed on Jan. 16, 2015.

(51) Int. Cl. B60J 11/04

(52) U.S. Cl. CPC B60J 11/04

(57) ABSTRACT

A disclosed daily use protective vehicle cover comprises an anchoring system configured to cover horizontal surfaces on the vehicle including all windows down to the door handles on each side of the vehicle and the hood and trunk. The cover also includes an upside down pocket with an open portion facing downward to fit over a top part of at least one door and therefore anchor the pocket to the door regardless of whether the door is open or closed. The cover further includes a plurality of anti-theft devices configured to prevent the cover from being pulled off the vehicle at least at one of the doors and at a front hood and a rear trunk thereof, the devices comprising a bulky object sewn into an underside of the cover. A method includes anchoring a hood and trunk end of the cover prior to attaching the sides of the cover.

This application claims the benefit of the priority date of earlier filed U.S. Provisional Patent Application Ser. No. 62/104,571 titled ‘Protective Vehicle Cover’ filed Jan. 16, 2015 by Bobby Ward and Ashleigh Ward incorporated herein by reference in its entirety.

### BACKGROUND OF THE INVENTION

Conventional motor vehicle covers are not easy to install. Many commercially available vehicle covers require nylon straps or a cable to secure a cover underneath a vehicle. Also such conventional covers only cover a motor vehicle and have no functional parts. Accordingly, conventional motor vehicle covers resemble a non-descript sheet tied down at its ends under the motor vehicle.

Conventional motor vehicle covers usually cover the entire vehicle for storage (non-daily use) or fully cover certain vehicle horizontal surfaces including windows but do not allow easy entry into the vehicle. Conventional vehicle covers also do not facilitate installing or uninstalling the vehicle cover on windy days.

There is therefore a long felt need in the art to protect vehicle surfaces from fading including color fading of convertible tops exposed to heat, tree sap, bird poop, dirt, dust, hail, ice, snow, and other airborne pollutants and from animals scratching the paint surfaces when walking on the horizontal surfaces of the user's vehicle with claws such as birds, cats, and other creatures.

### SUMMARY OF THE INVENTION

A disclosed protective vehicle cover, comprising a fabric type cover and anchoring system thereof is configured to cover a plurality of horizontal surfaces on the vehicle including all windows down to the door handles on each side of the vehicle and the hood and trunk. The disclosed cover also includes an upside down pocket configured with an open portion facing downward to fit over a top part of at least one door and therefore anchor the pocket to the door regardless of whether the door is open or closed. The disclosed cover further includes a plurality of anti-theft devices configured to prevent the cover from being pulled off the vehicle at least at one of the doors and at a front hood and a rear trunk thereof, the devices comprising a bulky object sewn into the cover.

A method is also disclosed for protectively and securely covering a vehicle. The method includes anchoring a hood and trunk end of a fabric type cover configured to cover a plurality of horizontal surfaces on the vehicle and anchoring a plurality of sides of the vehicle including all windows down to the door handles including side view mirrors. The method also includes operatively covering at least one door of the vehicle to the cover via an upside down pocket configured with an open portion facing downward to fit over a top part of at least one door and therefore anchor the pocket to the door regardless of whether the door is open or closed. The method further includes installing a plurality of anti-theft devices configured to prevent the cover from being pulled off the vehicle at least at one of the doors and at a front hood and a rear trunk thereof, the devices comprising a bulky object sewn into the cover.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a top left perspective view of a daily use protective vehicle cover and a zippered open door in accordance with an embodiment of the present disclosure.

FIG. 2 is a top left perspective view of a daily use protective vehicle cover and a zippered closed door in accordance with an embodiment of the present disclosure.

FIG. 3 is a bottom view of a daily use protective vehicle cover illustrating operational components in accordance with an embodiment of the present disclosure.

FIG. 4 is an illustration of a rolled-up daily use protective vehicle cover attached at a vehicle rear in accordance with an embodiment of the present disclosure.

FIG. 5 is a front perspective illustration of an unrolled daily use protective vehicle cover attached at a vehicle front in accordance with an embodiment of the present disclosure.

FIG. 6 is a close up detail of the vehicle front attachment of the daily use protective vehicle cover in accordance with an embodiment of the present disclosure.

FIG. 7 is an alternate vehicle front attachment of the daily use protective vehicle cover to a license plate in accordance with an embodiment of the present disclosure.

FIG. 8 is a side perspective illustration of an unrolled daily use protective vehicle cover attached at a vehicle front and rear in accordance with an embodiment of the present disclosure.

FIG. 9 is a left side perspective view of a deployed and attached daily use protective vehicle cover in accordance with an embodiment of the present disclosure.

FIG. 10 is a left side perspective view of a deployed and attached daily use protective vehicle illustrating an opened driver's side door in accordance with an embodiment of the present disclosure.

FIG. 11 is an inside perspective view of an opened driver's side door illustrating an upside down pocket zippered daily use protective vehicle cover in accordance with an embodiment of the present disclosure.

FIG. 12 is an inside perspective view of an open driver's side door illustrating an anti-theft device for the daily use protective vehicle cover in accordance with an embodiment of the present disclosure.

FIG. 13 is a rear perspective view of a covered and opened trunk and an anti-theft device attached thereto for the daily use protective vehicle cover in accordance with an embodiment of the present disclosure.

FIG. 14 is a flow chart of a method of secured installation of the daily use protective vehicle cover in accordance with an embodiment of the present disclosure.

Throughout the description, similar and same reference numbers may be used to identify similar and same elements in the several embodiments and drawings. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Presently, there is no motor vehicle cover that interchangeably allows covering the vehicle while at the same time allowing easy entry into the covered vehicle in an operative position. The present disclosure seeks to provide solutions to these problems by providing a motor vehicle cover device that can be used on a daily basis and allows easy entry into the motor vehicle after it is covered, in its operative position. Limitations of the disclosure prevent the cover from blowing onto the ground when installing or uninstalling the cover onto or off of the vehicle. This motor vehicle cover allows for interchangeably covering the vehicle while at the same time allowing easy entry into vehicle after it is covered by the user without having to fully or partially take the cover off any parts of the vehicle that are protected by the daily use vehicle cover. The vehicle cover also allows for easy installation and removal of the cover with the built-in “Anchoring System”.

The disclosure embodies a daily use protective vehicle cover for a user on a daily basis or just on weekends. The disclosure covers the horizontal surfaces of the vehicle including the windows on both sides down to the door handles. The vehicle cover, at the door handle level, is maintained around the circumference of the vehicle from the front, where it is attached just above the front license plate/grill/bumper of the vehicle. The disclosure is angled downward toward the front of the vehicle as compared to the rear of the vehicle because most vehicle front ends, including headlights and front license plates, are lower than most vehicle rear ends including taillights and rear license plates.

The cover continues on both sides to the rear end of the trunk lid/hatchback just above the rear license plate for vehicles where the license plate is attached to the trunk lid. Otherwise, the cover will extend at or just below the taillights of vehicles. The user's ability to enter the vehicle once the cover is in its' operative position is made available by use of a zipper sewn in an upside down pocket shape around the driver's side door starting just outside and below the side mirrors to the door handles that includes the driver's or passenger side doors or both doors. This makes the disclosed cover ideal for daily and weekend use. The zipper continues around the driver/passenger doors to just below the door handle of either side or both sides of the vehicle for each door.

Entry into the vehicle is also made available through one of the rear passenger doors of sedans if the owner chooses to have them installed in an embodiment of the disclosure. Two zippers on each side of the trunk lid/hatchback can also be installed at the owner's request to provide easy access to the trunk when the vehicle is covered. Access to the trunk is also available without the aforementioned two zippers but depends on the type of vehicle and cover designed therefore.

A unique feature of the Daily Use Protective Vehicle Cover is the secured “Anchoring System” of the cover before it is installed on or uninstalled off of the vehicle. This feature prevents the end of the cover the user is not handling, when installing or uninstalling the cover, from blowing onto the ground on windy days. The secured Anchoring mechanism allows the cover to stay in place until the cover is fully installed or uninstalled. It also helps prevent the cover from getting debris on it from the ground that can possibly scratch the vehicle paint surface as well as help to prevent the cover from getting dirty if it lands on the ground.

The disclosed cover is attached to the vehicle in 12 to 20 points on the underside of the cover as follows (coupes or sedans including SUV's and pick-up trucks): Front and rear license plates or front end of cars using tie-downs and rotating plastic hooks (2 of 20); Four plastic “J” hooks covered with vehicle cover fabric attached to both sides of front-end fender and/or rear-end fenders of the vehicle just above front/rear tires (6 of 20); Two elastic bands on both side view mirrors at the base (8 of 20); Upside down pocket/straps over driver's/passenger side doors (10 of 16); Velcro straps, Non-Velcro Straps or plastic “J” hooks around the front and rear door handles, two for coupes/four for sedans (12/14 of 20); Anti-theft mechanisms on both driver and passenger side doors at the top of the windows (16 of 20); Two anti-theft mechanisms on both sides of trunk lid (18 of 20); and Two optional anti-theft mechanisms, sown to the underside of the cover on the left and right sides just above where the engine hood would open, are used for long-term non-use of vehicle (20 of 20).

In an embodiment, an Anchoring System is built into the daily use protective vehicle cover. The anchoring of the vehicle cover before the DUPVC is installed or uninstalled off of the vehicle will prevent the end of the cover that is not being handled by the user, when installing or uninstalling the cover, from blowing onto the ground on windy days. This anchoring system will also help prevent debris from getting onto the cover that could scratch the paint surface of the vehicle and prevent the cover from getting dirty in the event it is blown from the vehicle and lands on the ground.

The cover will come rolled up from front to rear. The user will need to place the cover on the vehicle starting from the rear. At the rear of the vehicle, the cover will be first secured to the license plate/holder in one of two ways depending on the type of license plate holder used by the maker of the vehicle (bungee cord or plastic rotating hooks attached to wire between screws used to hold license plate on vehicle).

In another embodiment of the disclosure, a Bungee Cord/heavy duty elastic is sewn with both ends of a 27-inch long round bungee cord/elastic together forming a circle at the rear end of the cover. The circular cord/elastic is placed around the bottom of the license plate holder/license plate pulling each side up firmly to the top of the license plate where it is screwed-in to the license plate holder/vehicle.

In a further embodiment of the disclosure, Plastic Rotating Hooks will be attached a 1-inch wide fabric sewn to the underside of the cover that will be 2 to 4 inches in length. Two inches of bungee cord/elastic is sewn at the end of the fabric that will be sewn to the plastic hook. The plastic hook will be attached to a 24 gauge Steel Galvanized Wire that is 10-inches long and will need to be installed/wrapped once around each of the two screws used to hold the license plate in place by the user. The user would unscrew the screws just enough to wrap the thin, but strong, wire around each screw then re-tighten each screw. The user should also ensure there is 1-inch of slack in the line between the two screws.

Based on using one of the two methods for anchoring the cover to the rear of the vehicle, the user will then unroll the cover toward the front of the vehicle until it stops just above the front license plate and/or below the headlights if front license plates are not present. The user proceeds to repeat instructions regarding placing bungee cord/elastic around front license plate or use of plastic rotating hook with wire as stated for rear license plates. In states where there are no license plates required for front of vehicles, the user will be provided with a tie-down to attach to a designated area of the front end of the vehicle (exact location will be shown instructions with picture).

At the end of the front area of the cover, in this instance, there will be fabric sewn to the front end of the cover with a rotating plastic hook that is attached to the tie-down noted above with anchoring cover at rear of vehicle. Once the anchoring system is completed, the user may unfold the cover from front to rear and from left side to right side until the DUPVC is covering all horizontal surfaces of the vehicle (including the windows on all sides down to the door handles/license plates/headlights/taillights for vehicles where front license plates are not required and rear license plates are not attached to trunk lid).

In yet another embodiment, two plastic “J” hooks covered with car cover fabric attach to both sides of the front-end fender of the vehicle just above front tires. There may be two ways the DUPVC (daily use protective vehicle cover) can be attached to the front of a vehicle depending on the type of vehicle the user wants to cover. The first way embodies two plastic “J” shaped hooks turned sideways with car cover fabric covering each hook that attach to the front-end fender of the vehicle just above the front tires at the level just above the license plate or just below the headlights. These hooks secure the cover to the front-end of the vehicle. The fabric covering the plastic hooks may be sewn underneath the cover with elastic at the end of each of the two hooks to ensure a firm fit across the front of the vehicle to achieve a clean elegant look.

The second way the cover may be attached to the front of the vehicle, depending on the type of vehicle, includes straps and 1-inch upholstery rope sewn at the ends of the straps. In this embodiment, there will be one strap sewn to each end of the cover that may be pulled to go under the front of the vehicle hood while the hood is partially open for most vehicles. Other vehicles may have two 12-inch and two 5-inch straps with the 1-inch upholstery ropes sewn on them to be placed under the hood of the vehicle. Once the hood is closed, the straps will help secure the cover to the vehicle during windy days and act as anti-theft devices.

This same process would be repeated using the trunk lid/hatchback in the rear of the motor vehicle. Finally, there will be two 20-inch straps; one each will be place inside the driver and passenger side doors with 1-inch upholstery rope sown on them. The two straps will be sown near the door handles on each side of the interior of the vehicle cover where each door opens to enable the user to place the straps inside the vehicle.

Other embodiments of the disclosure include side view mirrors with elastic at the base of the mirror used to secure the disclosed cover to the vehicle. Elastic is sewn into one half of the circumference of the side view mirrors covers, driver's/passenger doors, to help secure the cover to the vehicle. The elastic will be sewn to the bottom or right side of the circular cover that covers the mirrors depending on whether the seams are horizontal/vertical.

Embodied methods keep the vehicle cover attached to door(s) when opened. The upside down pocket/straps that are used to hold the disclosed cover in place when the driver's/passenger side doors are opened and closed. The pocket/straps are sewn to the DUPVC in one of three ways depending on the type vehicle and whether it is a coupe or sedan as follows. The upside down pocket with the center cut out. This embodied version of the upside down pocket is sewn to the inside of the vehicle cover in the shape of the door window with 4 to 9 inches of borders at all four inside edges of the door window including just above the area where the window would be completely down. The center area of the upside down pocket opens up like a donut hole but wider. The inner borders' width or height is based on whether the vehicle is a coupe or sedan. There are also 3 inches of elastic in the center of the bottom border to ensure a firm fit around the bottom part of the door window.

An embodiment is also disclosed including the pocket without the center cut out. This embodiment of the upside down pocket is sewn to the inside of the vehicle cover in the shape of the door window with no borders to the inside edges of the door windows. The center area of this upside down pocket will not be open but will be all fabric. This version will also have 3 inches of elastic in the center of the bottom edge to ensure a firm fit around the bottom part of the door window/upside down pocket.

Another embodiment includes the use of Horizontal and Vertical Straps. The Horizontal/Vertical Strap embodiment may be attached to the cover with two horizontal straps that are sewn just beneath the zipper on both sides of the vertical parts of the zipper that are one third from the top and one third from the bottom of the driver's/passenger side door window. There are also three vertical straps sewn just below the zipper running horizontally at the top of the door window sewn to both horizontal straps that are sewn to the vertical areas below the zipper. These straps will be pulled over the driver's/passenger side door windows to secure the cover to the vehicle in the event either of the doors are opened and closed.

Door handle area attachments may be used to secure the cover to the vehicle. Included are three ways of securing the cover to the door handle areas of a vehicle: “Hook and Loop Straps”, “J” Hooks, and other Straps. The hook and loop straps, also known as Velcro Straps™ and “J” hooks may be used for vehicles with door handles where the user needs to place their fingers over the top and around the handle to open the vehicle door. Other Straps will be used for all other vehicles that do not allow the users to place their fingers over the top and around the door handles to open the vehicle doors. The “Velcro™ Straps” may be vertically sewn underneath the cover directly over the door handles that will wrap under the door handle and up above a handle to be attached via Velcro™ to the upper side of the strap sewn underneath the cover to secure the cover to the vehicle.

Other “J” shaped plastic hooks may be vertically sewn to the underside of the cover directly over the door handle with the “J” shaped plastic hooks sewn within the car cover fabric with straps at the end and elastic sewn within the straps. The hooks that are sewn underneath the cover may be pulled down and positioned to go under the bottom part of the door handle where the tension of the elastic will hold the “J” hooks firmly in place while at the same time securing the cover to the vehicle in that area. Non-Velcro Straps may be horizontally sewn underneath the cover at or just below the door handles. The 7 to 13-inch straps may extend just inside the interior of the vehicle with a super magnet sewn within the fabric that will stick to the metal/screw to ensure the fabric maintains a horizontal position (length of straps depends of thickness of vehicle door).

An embodiment includes a 1-inch thick upholstery rope sewn at the end of the strap to ensure the cover is secured to the inside of the vehicle at the door handle areas. The Velcro Straps™, “J” Hooks, and/or Non-Velcro Straps (two for coupes and four for sedans) may not be apparent by anyone looking at the outside of the DUPVC installed on a vehicle.

Front doors anti-theft mechanisms are used to secure and impede theft of the embodied cover. Anti-theft mechanisms are disposed on both driver and passenger side doors at the top of the door windows on each inside. In anyone of the three methods noted above to secure the cover to the door windows, whether there is a zipper sewn to the cover for entry or not, fabric is sewn into the cover just below the zipper at the door or 1-inch below where the door closes at the top when there is not a zipper on the passenger door window. The fabric used to secure the cover to the vehicle may be 7-18″ wide and 5-9″ long with a 1-inch thick upholstery rope sewn at the end of the 5-9″ long fabric to help secure the cover to the inside of the vehicle and help prevent cover from being stolen (first anti-theft mechanism). The width and length of the fabric will depend on the type and size of the vehicle. The 7-18″ wide fabric may be sewn 4 to 5 inches from the side of the door window where the user would enter the vehicle on either sides.

Trunk lid anti-theft mechanisms are also used in an embodiment to secure and impede theft of disclosed cover. There may be two anti-theft mechanisms disposed on both sides of trunk lid/hatchback. The 4 to 6-inch wide by 7 to 10-inch long fabric may be vertically sown underneath the cover about one quarter of an inch from the vertical hem on the rear of the vehicle cover. This fabric extends just inside the interior of the vehicle trunk/hatchback with super magnets sewn within the fabric to ensure the fabric stays hanging downward or horizontally inside the trunk/hatchback areas. There may also be a 1-inch thick upholstery rope sown at the end of the 7 to 10-inch long fabric to ensure the cover is secured to the inside of the vehicle when the trunk lid/hatchback is closed. The fabric with the upholstery rope sewn at the end will help secure the cover to the rear end of the vehicle and help prevent the cover from being stolen.

Optional Engine Hood anti-theft mechanisms are included in an embodiment to also secure and impede theft of the disclosed cover. The anti-theft mechanisms are sewn to the underside of the cover on the left and right sides just above where the engine hood would open. There are also 1-inch thick upholstery ropes sewn at the end of each 3 to 6-inch long fabric sections to ensure the cover is secured to the inside of the engine area when the engine hood is closed. The fabric with the upholstery ropes sewn at the ends helps secure the cover to the front end of the vehicle and helps prevent the cover from being stolen.

After vehicle is covered, the user may unzip the zipper that takes the shape of the driver/passenger side door windows to the door handles or trunk lid/hatchback to enter the vehicle while the vehicle remains covered in its' operative position. When the user has concluded the need to be inside the covered vehicle, the user may close the driver/passenger side door then re-zip the zipper to put the vehicle in its' complete operative position, covered and zip closed.

The daily use vehicle cover protects the interior of the vehicle against the sun and heat damaging rays while at the same time helping to maintain that new vehicle look of the seats and dashboard of the user's vehicle. The user can implement these protections on a daily basis or just the weekends when using the cover. The disclosed cover provides access to the interior of the user's vehicle on a daily basis, while it is covered, to retrieve and/or place items in it, including the user to read, relax, or rest. The disclosed cover also enables the user to have privacy in public settings in the user's vehicle where the user could read, relax, or just rest in private under the daily use vehicle cover (for example, the user have time to kill because user is early or must wait unexpectedly for someone). The user will now be able to enjoy interior of vehicle when not driving and experience that enjoyment in private under the cover. The user will be advised, within instructions for cover, when seeking privacy in public settings to always legally park the vehicle in a safe public area and to turn on the engine to obtain cool air or heat when outside temperatures warrants such use of a running engine.

The daily use vehicle cover allows the user entry into the vehicle's interior including the trunk/hatchback without removing the vehicle protective cover from its operative position covering the vehicle. The disclosed anchoring system is designed for the daily use of the vehicle cover and enables the user to install and uninstall the cover onto the vehicle without the end of the cover the user is not handling at the time blowing onto the ground on windy days. This anchoring system thus prevents the cover from falling onto the ground getting dirt and/or debris on the cover that could scratch the vehicle's paint surfaces.

The daily use vehicle cover enables the user to install and uninstall the cover onto/off of the vehicle in a standing position while only bending at the waist to install the anchoring system at the license plate level on both ends of the vehicle. There is no need for user to throw straps or cables underneath the vehicle that would need to be retrieved by the user on the other side. As compared to existing vehicle covers that requires the user to throw straps underneath the vehicle on one side to then have the user get on their knees to retrieve the straps to attach them to the other side of the vehicle to secure the cover in place on the vehicle for windy days. The same process noted above must be done to lock the cover to the vehicle to help prevent theft of the cover.

Preferably, the disclosed vehicle cover has a zipper sewn around the driver and/or passenger side door windows to the door handles and/or the trunk lid/hatchback so that the covered vehicle can interchangeably be fully covered and allow entry into the vehicle through the use of the zipper(s) surrounding the above mentioned doors and/or trunk lid/hatchback being unzipped. The intent of the zipper is to make it extremely convenient for the user to enter the covered vehicle to retrieve a forgotten item; to store an item on the user's person into the covered vehicle with ease and convenience; or for the user to get into the covered vehicle to obtain some privacy in a public setting by just unzipping then re-zipping the zipper on the driver/passenger side door window(s).

The intent of the door zipper is also to enable the user to get in the covered vehicle to read, relax or rest in private under the covered vehicle at public rest stops when taking long road trips to avoid the expense of a hotel to take an hour or so to rest before driving again or to provide privacy in any public setting when legally parked in a safe area when outside temperatures are at a comfortable level, again, to read, relax or rest. To enjoy privacy in public settings after the user has installed the cover onto the vehicle, a different method is disclosed for sedans as compared to coupes. For owners of sedans, the user may unzip the driver/passenger door then get into the vehicle closing the driver/passenger door upon being comfortably settled in the vehicle.

Within the window area of the door that allows access to the interior of vehicle for sedans, there may be a zipper sewn in the shape of a backward letter “L” but curve at the vertical/horizontal intersections. This zipper sewn into window area of the door window may be used if the owner chooses to close the door of the covered vehicle while inside the vehicle to read, relax, or rest in it for short time. To unzip the zipper in the door window, the user would roll down the window of the closed door of the covered sedan vehicle. The user unzips the zipper and puts his/her arm out the opened zipper to zip close the zipper around the shape of the driver/passenger door window(s) down to the door handle areas. Once the vehicle cover is zipped close around the driver/passenger door(s), the user may zip close the zipper within the door window area and roll the window up to a safe level to allow air into the vehicle.

For owners of two door vehicles/coupes (no metal frame around windows) where the zipper will have exterior/interior zipper heads, the user may pull the exterior zipper head up just pass the side view mirror on the door before getting into the vehicle. The user may get into the vehicle before partially closing the door with the window fully up. After getting completely into the vehicle in a sitting position, the user may partially roll down the window. With the door and window partially opened, the user may begin pulling the interior zipper head from within the vehicle to start zippering him/herself in the vehicle while simultaneously closing the door until it is completely closed as the zipper curves into the vertical downward track toward the door handle.

Once the vehicle cover is zipped closed around the driver/passenger door(s) for the sedans or coupes, the user rolls the window up to a safe level to allow air into the vehicle to read, relax, or rest in private in the covered vehicle as compared to just completely rolling up the windows to use the air conditioner or heater of the vehicle while the engine is running

In an embodiment of the disclosure, the vehicle cover can be conveniently installed or removed from the vehicle and conveniently stowed within its' storage bag in the trunk of the vehicle. To facilitate such folding and unfolding, the user detaches all devices via methods of securing the cover to the vehicle except the front and rear anchoring system and simply pulls the cover up on top of the vehicle on each side until the width of the cover is about 2.5 feet or less, depending on the size of the vehicle. The user goes to the front of the vehicle to detach the front anchoring system then begins rolling the cover toward the rear of the vehicle safely from the sidewalk side of the parked vehicle. The user would then detach the rear anchoring system using the bungee cord/elastic used around the license plate to wrap around the rolled up cover to secure it in that position and places the cover in the storage bag.

In embodiments where the plastic hook is attached to the wire used to anchor the cover to the vehicle, the user detaches the hook from the wire on the license plate. then wrap the fabric the hook is attached to in the same direction of the rolled up cover to attach the hook to elastic pre-sown in a circular shape to the inside of the cover. The reverse is done to install the cover onto the vehicle as noted herein.

The disclosed cover may be formed from an elongated sheet of material in an embodiment. This material is made using water resistant material with four layers of protection. This vehicle cover allows the user to have access to the vehicle on the driver side front door; any one of the passenger doors; and the trunk lid/hatchback of the vehicle. The disclosed “Anchoring System” includes a bungee cord and/or plastic hooks attached to rear license plate holder and the front license plate holder/grill/bumper. The user is able to easily install and uninstall the cover on windy days, without the end of the cover being handled by the user, or being blown onto the ground.

The front-end portion of the disclosed cover is reasonably connected to the license plate, grill, or bumper as well as the side front fenders. Attachment at the side view mirrors and the driver/passenger door windows impedes theft, with the same reasonable connect ability made to the rear trunk lid/hatchback and rear end of vehicle including the license plate. This longitudinally intermediate portion is adapted to overlie and shield essentially the entire horizontal surface of the vehicle to include the vertical windows on both sides down to the door handles/license plates/headlights/taillights.

Closure of the engine hood, both driver/passenger doors, and trunk lid/hatchback thus firmly secures the vehicle cover in place in its operative position while also acting as anti-theft mechanisms. While in its operative covered position, the user is still able to access the interior of the vehicle in case the user forget to retrieve or leave an item in the vehicle that is on the user's person. In its covered operative position, the user can also get into the covered vehicle to enjoy privacy in a personal setting. After the user zips the cover closed from inside of the vehicle, the user may enjoy private comfort to read, relax, or rest in private inside the vehicle when legally parked in a safe area.

The vehicle cover can be conveniently installed and uninstalled from the vehicle in a standing position and conveniently stowed within its' storage bag in the trunk of the vehicle. To facilitate such folding and unfolding of the vehicle cover, the user detaches all devices via methods of securing the cover to the vehicle while folding up the cover except the front and rear anchoring system and simply pull the cover up on top of the vehicle on each side until the width is about 2.5 feet or less depending on the size of the vehicle. The user goes to the front of the vehicle to detach the front anchoring system then begin rolling the cover toward the rear of the vehicle safely from the sidewalk side of the parked vehicle. The user may detach the rear anchoring system using the bungee cord/elastic used around the license plate to wrap around the rolled up cover to secure it in that position then place the cover in the storage bag. If the plastic hook attached to the was used to anchor the cover, the user detaches the hook from the wire on the license plate and wraps the fabric in the same direction of the rolled up cover to attach the hook to elastic pre-sown in a circular shape to the inside of the cover. The reverse is done to install the cover onto the vehicle as noted herein.

Throughout the present disclosure, the term ‘operational’ refers to use of the vehicle during running or idling or parking conditions and any other condition when a driver or passenger is using the vehicle. The terms front, rear, up and down refer to common prepositions for a driver or passenger of the vehicle. The terms anchor and attachment device are synonymous and refer to fixing the daily use protective vehicle cover in a certain position on the vehicle.

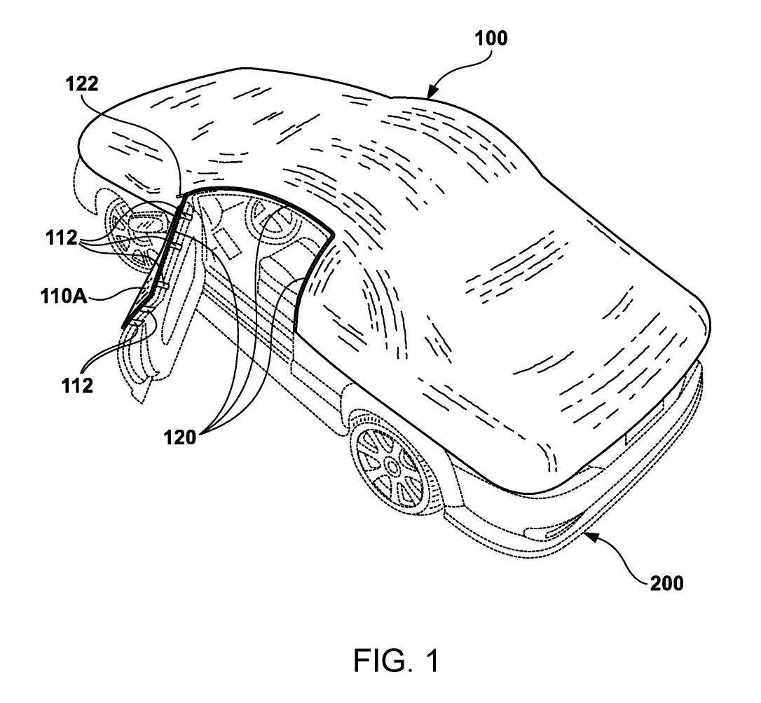

FIG. 1 is a top left perspective view of a daily use protective vehicle cover and a zippered open door in accordance with an embodiment of the present disclosure. The depiction includes the DUPVC 100, the window portion cover 110A, the door cover nylon straps 112, the door zipper 120 and the door zipper head 122. The door cover nylon straps secure the door cover portion to the door and the door cover zipper 120 allows the door cover portion to be attachably secured to the DUPVC. The vehicle 200 is a two door coupe but could be any other vehicle configuration according to automobile convention makes, models and custom designs.

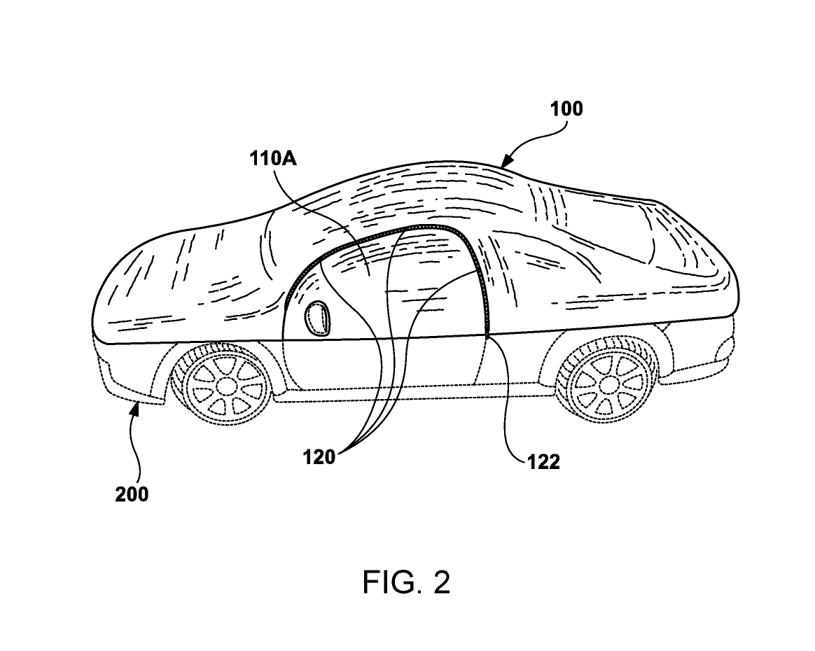

FIG. 2 is a top left perspective view of a daily use protective vehicle cover and a zippered closed door in accordance with an embodiment of the present disclosure. The reference numbers of FIG. 1 are same and similar to those in this depiction with the difference that the vehicle door is closed and the door cover thereof is attachably secured thereto.

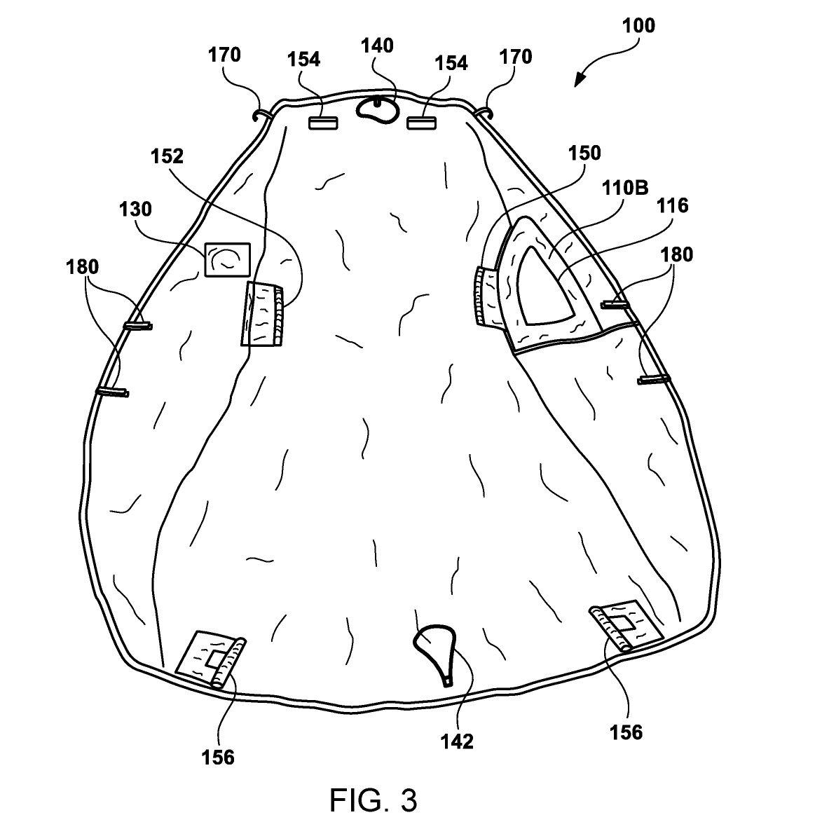

FIG. 3 is a bottom view of a daily use protective vehicle cover illustrating operational components in accordance with an embodiment of the present disclosure. The depiction of the DUPVC 100 includes the upside down pocket window portion 110B which preclude the use of the straps 112 (not depicted), clear window portion 116, side mirror cover 130, rear attaching loop 140, front attaching loop 142, driver's side anti-theft device 150, passenger side anti-theft device 152, front anti-theft devices 154, rear anti-theft devices 156, fabric covered front J hooks 170, and hook and loop straps 180. The attachment devices are disposed on an inside of the DUPVC to avoid tampering and also to present a clean and professional appearance to the disclosed cover. The attachment devices are also disposed on an inside of the DUPVC for functional reasons being closer to the vehicle surfaces and operational components.

The protective vehicle cover is configured to taper from a smaller front end to a larger rear end thereof in accordance with many popular forward cab vehicle designs. Embodiments of the disclosed fabric type cover comprise transparent window portions and respective interior flaps configured to cover the transparent window portions.

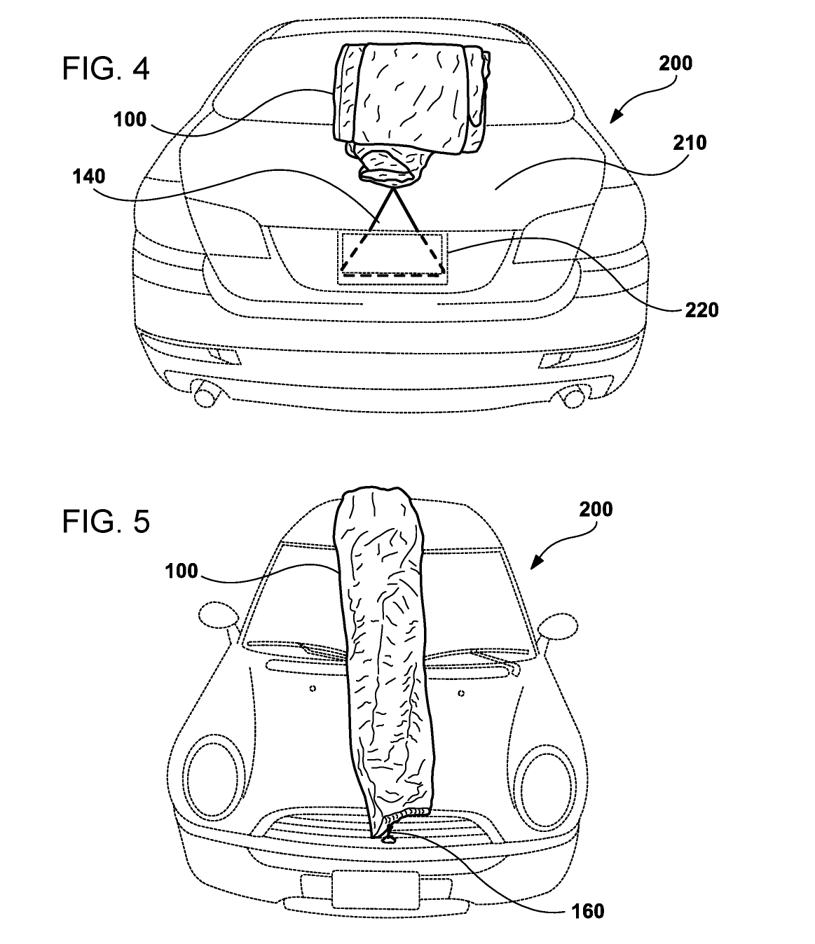

FIG. 4 is an illustration of a rolled-up daily use protective vehicle cover attached at a vehicle rear in accordance with an embodiment of the present disclosure. The DUPVC is secured at only the rear end of the vehicle prior to deployment over the vehicle and attachment thereto. The method for deployment is discussed and disclosed herein and the benefits and efficiencies claimed in appurtenance thereto. The vehicle trunk 210 may include the license plate 220 in some makes and models and custom designs.

FIG. 5 is a front perspective illustration of an unrolled daily use protective vehicle cover attached at a vehicle front in accordance with an embodiment of the present disclosure. The DUPVC is secured at both the front end and the rear end of the vehicle to enable a methodical and secured deployment across the substantially horizontal surfaces of the vehicle. The front attachment hook 160 is in communication with the front grill of the car but in other embodiments may be in communication with other vehicle components in order to secure the disclosed cover thereto.

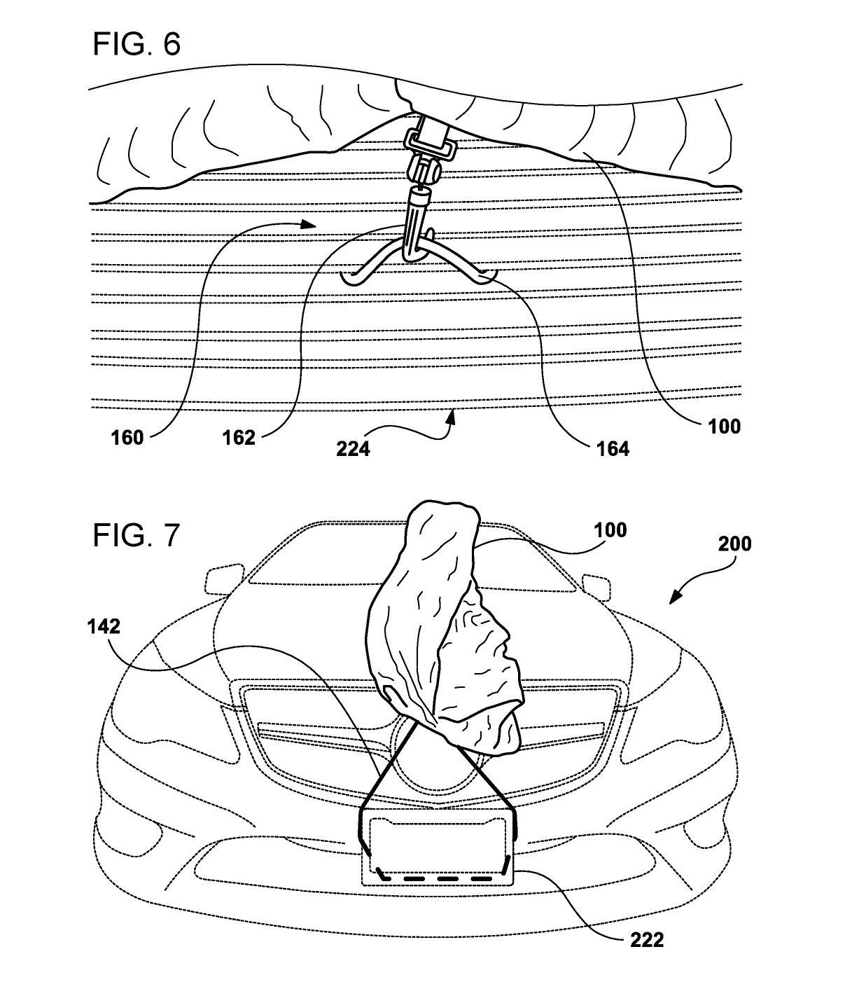

FIG. 6 is a close up detail of the vehicle front attachment of the daily use protective vehicle cover in accordance with an embodiment of the present disclosure. The swivel hook 162 is in communication with a loop 164 attached to the grill of the vehicle 224. Other hooks are included in embodiments of the disclosure allowing for rotational freedom about the cover for different makes and models and custom vehicle designs.

FIG. 7 is an alternate vehicle front attachment of the daily use protective vehicle cover to a license plate in accordance with an embodiment of the present disclosure. The front attaching loop 142 is configured to elastically or frictionally fit to a license plate or a license plate holder thereof and secure the DUPVC to the vehicle front component(s) depending on make, model and design of the vehicle.

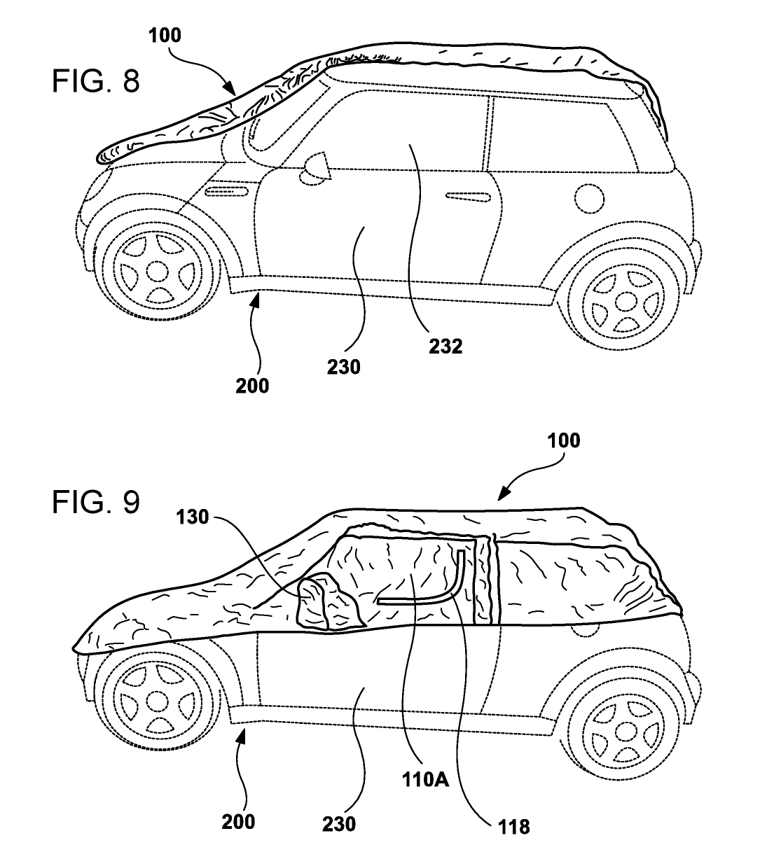

FIG. 8 is a side perspective illustration of an unrolled daily use protective vehicle cover attached at a vehicle front and rear in accordance with an embodiment of the present disclosure. The illustration clearly shows an intermediate step in the method of deploying the disclosed covering or removing it from the vehicle. The vehicle driver's side door 230 and vehicle window 232 are yet uncovered.

FIG. 9 is a left side perspective view of a deployed and attached daily use protective vehicle cover in accordance with an embodiment of the present disclosure. The vehicle driver's side door 230 horizontal surfaces are covered and the vehicle window 232 is fully covered to provide protection to horizontal surfaces and privacy to the user. The side view mirror cover 130 is clearly depicted and the backward L shaped flap opening 118 is shown. Embodiments include a zipper to attach the backward L shaped flap to the rest of the disclosed cover. Same or similar reference numbers are depicted in common with other drawings to show same or similar components. The protective vehicle cover is configured to taper upward from a front end to a rear end thereof in accordance with many popular forward cab vehicle designs. This is clearly illustrated in the present figure where the front wheel wells are covered but the rear wheel wells are not.

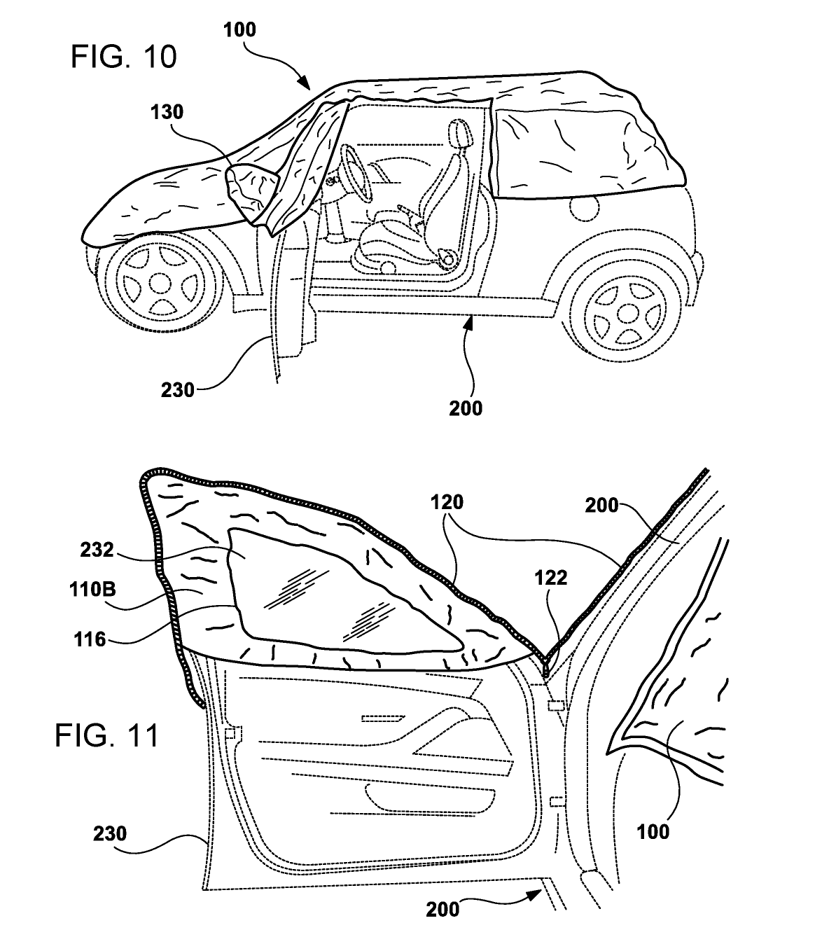

FIG. 10 is a left side perspective view of a deployed and attached daily use protective vehicle illustrating an open driver's side door in accordance with an embodiment of the present disclosure. Same or similar reference numbers are depicted in common with other drawings to show same or similar components.

The illustration clearly shows the DUPVC upside down pocket fit to the vehicle door in an open position.

FIG. 11 is an inside perspective view of an open driver's side door illustrating an upside down pocket zippered daily use protective vehicle cover in accordance with an embodiment of the present disclosure. Same or similar reference numbers are depicted in common with other drawings to show same or similar components. The illustration clearly shows the DUPVC upside down pocket fit to the inside of the vehicle door in an open position.

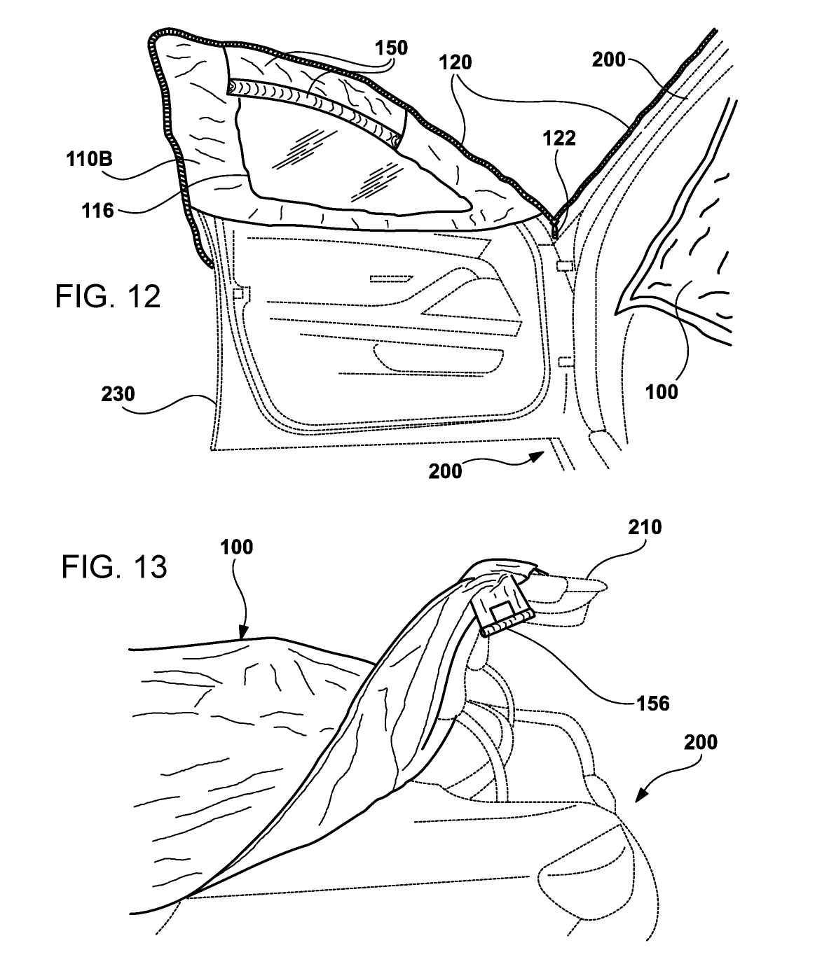

FIG. 12 is an inside perspective view of an open driver's side door illustrating an anti-theft device for the daily use protective vehicle cover in accordance with an embodiment of the present disclosure. The driver's side door anti-theft device 150 is disposed below the door to vehicle zipper and seam 120 to fall within the interior of the vehicle and prevent theft of the disclosed cover. Same or similar reference numbers are depicted in common with other drawings to show same or similar components.

FIG. 13 is a rear perspective view of a covered and open trunk and an anti-theft device attached thereto for the daily use protective vehicle cover in accordance with an embodiment of the present disclosure. Same or similar reference numbers are depicted in common with other drawings to show same or similar components. The rear anti-theft device 156 falls within the trunk space of the vehicle thus preventing theft of the DUPVC while installed over the vehicle.

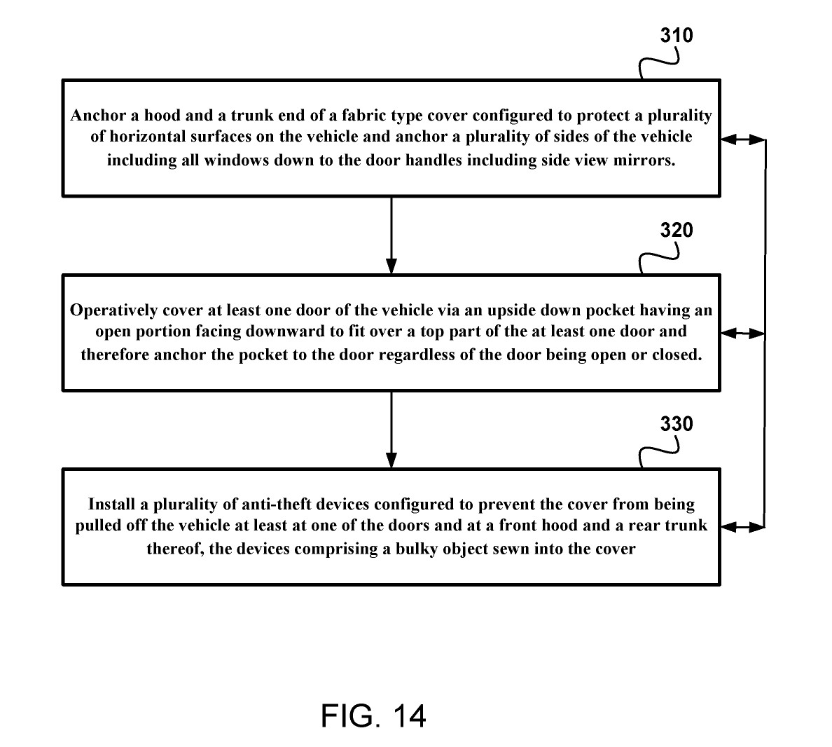

FIG. 14 is a flow chart of a method of secured installation of the daily use protective vehicle cover in accordance with an embodiment of the present disclosure. The method includes anchoring 310 a hood and trunk end of a fabric type cover configured to cover a plurality of horizontal surfaces on the vehicle. The method also includes anchoring 310 a plurality of sides of the vehicle including all windows down to the door handles including side view mirrors. The method additionally includes operatively 320 covering at least one door of the vehicle to the cover via an upside down pocket configured with an open portion facing downward to fit over a top part of at least one door and therefore anchor the pocket to the door regardless of whether the door is open or closed. The method further includes installing 330 a plurality of anti-theft devices configured to prevent the cover from being pulled off the vehicle at least at one of the doors and at a front hood and a rear trunk thereof, the devices comprising a bulky object sewn into the cover.

The flow chart illustrates the methodical and secure deployment of the DUPVC as disclosed herein with benefits and efficiencies appertaining thereto.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents to be included by reference in a non-provisional utility application.

What is claimed is:

1. A protective vehicle cover, comprising:
a fabric type cover and anchoring system thereof configured to cover a plurality of horizontal surfaces on the vehicle including all windows down to the door handles on each side of the vehicle and the hood and trunk;
an upside down pocket configured with an open portion facing downward to fit over a top part of at least one door and therefore anchor the pocket to the door regardless of whether the door is open or closed; and
a plurality of anti-theft devices configured to prevent the cover from being pulled off the vehicle at least at one of the doors and at a front hood and a rear trunk thereof, the devices comprising a bulky object sewn into the cover.

2. The protective vehicle cover of claim 1, wherein the vehicle cover extends to one of just above a license plate in a front and a rear of the vehicle and just below a headlight and a taillight in a front and a rear of the vehicle provided there are no plates in a front and in a rear thereof.

3. The protective vehicle cover of claim 1, wherein the fabric type cover is configured to taper upward from a front end to a rear end thereof in accordance with forward cab vehicle designs.

4. The protective vehicle cover of claim 1, further comprising at least one side mirror cover configured to cinch around a side mirror of the vehicle via an elastic in the side mirror cover.

5. The protective vehicle cover of claim 1 wherein the anchoring system includes a plurality of side attachment devices, and at least one front attachment device and at least one rear attachment device.

6. The protective vehicle cover of claim 1 wherein the fabric type cover comprises transparent window portions and respective interior flaps configured to cover the transparent window portions.

7. The protective vehicle cover of claim 1, wherein the upside down pocket is configured from the cover for at least one door of the vehicle and attachably removable from a portion of the cover by a zipper there between.

8. The protective vehicle cover of claim 1, wherein the upside down pocket is configured to cover a window portion of a door of the vehicle.

9. The protective vehicle cover of claim 1, wherein the anti-theft devices are sewn into the cover just below at least one door zipper in the upside down pocket and just below where the front hood and the rear trunk close with a portion of the cover pointing downward and the bulky object sewn adjacent thereto.

10. The protective vehicle cover of claim 1, further comprising a backward L shaped flap opening in the upside down door cover, the backward L shaped flap opening configured to allow a user to operate the door zipper from inside the vehicle there through.

11. The protective vehicle cover of claim 1, wherein the anchoring system further comprises a front and a rear attaching loop each configured to attach an end of the protective vehicle cover to one of a respective license plate holder and a license plate.

12. The protective vehicle cover of claim 1, wherein the anchoring system further comprises at least one fabric covered “J” hook configured to attach the protective vehicle cover to a component of the vehicle.

13. A method for protectively and securely covering a vehicle, comprising:
anchoring a hood and trunk end of a fabric type cover configured to cover a plurality of horizontal surfaces on the vehicle and anchoring a plurality of sides of the vehicle including all windows down to the door handles including side view mirrors;
operatively covering at least one door of the vehicle via an upside down pocket configured with an open portion facing downward to fit over a top part of at least one door and therefore anchor the pocket to the door regardless of whether the door is open or closed; and
installing a plurality of anti-theft devices configured to prevent the cover from being pulled off the vehicle at least at one of the doors and at a front hood and a rear trunk thereof, the devices comprising a bulky object sewn into the cover.

14. The method for protectively and securely covering a vehicle of claim 13, further comprising anchoring the hood and trunk end of the fabric type cover prior to anchoring the sides and the side view mirror.

15. The method for protectively and securely covering a vehicle of claim 13, wherein operatively covering at least one door of the vehicle to the cover further comprises zippering the upside down pocket to the cover.

16. The method for protectively and securely covering a vehicle of claim 13, wherein operatively covering at least one door of the vehicle to the cover further comprises zippering the upside down pocket to the cover from an inside of the vehicle.

17. An operational vehicle cover, comprising:
an upside down pocket configured with an open portion facing downward to fit over a top part of at least one door and therefore anchor the pocket to the door regardless of whether the door is open or closed; and
a plurality of anti-theft devices configured to prevent the cover from being pulled off the vehicle at least at one of the doors and at a front hood and a rear trunk thereof, the devices comprising a bulky object sewn into the cover.

18. The operational vehicle cover of claim 17, further comprising a backward L shaped flap opening in the upside down door cover, the backward L shaped flap opening configured to allow a user to operate the door zipper from inside the vehicle there through

19. The operational vehicle cover of claim 17, further comprising a plurality of side attachment devices and at least one front attachment device and at least one rear attachment device disposed on an underside of the operational cover.

20. The operational vehicle cover of claim 17, further comprising at least one fabric covered “J” hook configured to attach the protective vehicle cover to a component of the vehicle.
